(19) United States
(12) Patent Application Publication
(10) Pub. No.: US 2005/0117464 A1
(43) Pub. Date: Jun. 2, 2005

(54) Disk playback apparatus and method

(76) Inventor: Koji Akita, Iwaki-city (JP)

Correspondence Address: BRINKS HOFER GILSON & LIONE, P.O. BOX 10395, CHICAGO, IL, 60610, US

(21) Appl. No.: 10/963,998

(22) Filed: Oct. 13, 2004

(30) Foreign Application Priority Data
Oct. 16, 2003 (JP) 2003-355751

(51) Int. Cl. G11B 7/085; G11B 5/09

(52) U.S. Cl. 369/30.27; 369/47.21; 369/53.2

(57) ABSTRACT

A disk playback apparatus and method capable of improving the ease of operation when a plurality of pieces of content, which are recorded on one disk and for which the playback method is different, are provided. A system controller analyzes the type of content recorded on a disk to be played back and creates management information such that a different pseudo-slot number corresponds to each of the pieces of the recorded content on the basis of the analysis result when a plurality of different types of the recording information are recorded on the disk. This management information contains the pseudo-slot number and the details of the recorded content corresponding to each pseudo-slot number, for example, information for CD-DA, and MP3. When an operation section is operated by the user to specify the pseudo-slot number, a digital signal processing section plays back the recorded content corresponding to the pseudo-slot number.

### BACKGROUND OF THE INVENTION

1. Field of the Invention

The present invention relates to a disk playback apparatus and method for playing back a plurality of pieces of content, which are recorded on one disk and for which the playback method is different.

2. Description of the Related Art

Previously, a playback system to which a plurality of playback apparatuses such as CD players and DVD players are connected has been known (for example, refer to Japanese Unexamined Patent Application Publication No. 2003-91924 (pages 3 to 8, FIGS. 1 to 7)). In this playback system, devices of different categories (for example, CD players and DVD players) can be connected and each of the pieces of the recorded content can be played back. Furthermore, when devices of the same category (for example, a plurality of CD players) are connected, these devices can be assigned to an input selection item of the same name. As a result, the ease of operation when the number of connected devices of the same category is increased can be improved.

In recent years, new rewritable disk media such as CD-Rs and DVD-Rs have become popular, so that recording can be performed in accordance with an operation from a user in such a manner that different types of information, for example, information for CD-DA (audio CD) and information for MP3, coexist in one disk medium. However, in the playback system disclosed in Japanese Unexamined Patent Application Publication No. 2003-91924 above, considerations are made to such an extent that a plurality of devices of the same or different categories are connected, but considerations to such an extent that one apparatus plays back a disk medium on which a plurality of pieces of information are recorded, for which the playback method is different, are not made. Therefore, the ease of operation when the recorded content of such a disk medium is played back cannot be improved. For example, some of recent CD players are capable of playing back the recorded content of both a disk for CD-DA and a disk for MP3 by selectively interchanging the disks. However, when one disk is loaded, the playback method in accordance with the recorded content thereof is determined; therefore, when the information is recorded in such a manner that information for CD-DA and information for MP3 coexist in one disk, only the information of one of them is played back. Furthermore, when a disk changer capable of loading a plurality of disks at the same time is used, the playback method is determined in units of disks. For example, when a disk for CD-DA is loaded into slot 1 and a disk for DVD-video is loaded into slot 2, the user specifies the slot number and the playback method so as to play back a desired disk (there are cases in which, when the slot number is specified, the playback method for the disk loaded into that slot is automatically set). Therefore, if information for which the playback method is different is recorded on one disk, the information whose playback method differs from the playback method determined in such a manner as to correspond to one slot does not become a playback target even if that information is recorded on the disk loaded into this slot, and a case in which playback cannot be performed might occur.

### SUMMARY OF THE INVENTION

The present invention has been made in view of the above. An object of the present invention is to provide a disk playback apparatus and method capable of improving the ease of operation when a plurality of pieces of content, which are recorded on one disk and for which the playback method is different, are played back.

To achieve the above-mentioned object, in one aspect, the present invention provides a disk playback apparatus including: a recording information analysis section for analyzing the type of recording information recorded on a disk-shaped recording medium to be played back; a management information creation section for creating management information such that each of a plurality of pieces of the recording information corresponds to mutually different identification information on the basis of the analysis result by the recording information analysis section when a plurality of different types of the recording information are recorded on the disk-shaped recording medium; and a playback section for performing a playback operation on the basis of the recording information corresponding to the identification information.

In another aspect, the present invention provides a disk playback method including: a first step of analyzing a type of recording information recorded on a disk-shaped recording medium to be played back; a second step of creating management information such that each of a plurality of pieces of the recording information corresponds to mutually different identification information on the basis of the analysis result in the first step when a plurality of different types of the recording information are recorded on the disk-shaped recording medium; and a third step of performing a playback operation on the basis of the recording information corresponding to the identification information

Even when a plurality of types of recording information are recorded on a disk-shaped recording medium, by specifying identification information corresponding to each piece of recording information, each piece of recording information can be played back. Thus, it is possible to improve the ease of operation when the recording information is played back using a disk-shaped recording medium on which a plurality of types of recording information are recorded in a mixed manner.

The disk playback apparatus may further include a first display section for displaying the content of the management information created by the management information creation section. The disk playback method may further include a fourth step of displaying the content of the management information created in the second step. As a result, it becomes possible for a user to confirm the identification information corresponding to the recording information of each disk-shaped recording medium, and the ease of operation can be improved further.

Preferably, the management information includes the identification information and specific information of the type of the recording information corresponding to the identification information. As a result, it becomes possible for the user to specify each piece of identification information and the type of the recording information corresponding to each piece of the identification information, and thus, the ease of operation can be improved further.

The disk playback apparatus may further include a disk housing section in which a plurality of the disk-shaped recording media can be housed and from which one of the disk-shaped recording media, which is to be played back by the playback section, is selectively taken out. The management information creation section preferably creates the management information corresponding to a plurality of the disk-shaped recording media that are actually housed in the disk housing section. Alternatively, in the second step, preferably, the management information corresponding to a plurality of the disk-shaped recording media that are actually housed in the disk housing section is created. As a result, a playback with identification information being specified for one or a plurality of pieces of recorded content recorded on each of a plurality of disk-shaped recording media can be performed. Thus, the ease of operation when recording information is played back using one or more disk-shaped recording media on which a plurality of types of recording information are recorded in a mixed manner can be improved.

Preferably, different identification information is used with respect to the combination of the housing position of the disk housing section and the type of one or a plurality of pieces of recording information of the disk-shaped recording medium housed at each housing position. As a result, even when a plurality of pieces of recording information are contained in each of a plurality of disk-shaped recording media, it becomes possible to specify each piece of recording information using the identification information, and the ease of operation when the recording information is specified can be improved.

Preferably, the identification information is a virtual slot number having a different serial number. As a result, it becomes possible to manage the recording information recorded on each disk-shaped recording medium by using a virtual slot number similar to the slot number indicating the housing position of the disk housing section such as a disk changer. Thus, it is possible to realize satisfactory ease of operation that is compatible with a conventional apparatus provided with a disk changer.

Preferably, examples of the disk-shaped recording medium include a CD and a DVD, and the playback section performs a playback operation on both the CD and the DVD. Alternatively, in the third step, preferably, a playback operation is performed on both the CD and the DVD. In this manner, when it is possible to play back both the CD and the DVD, the number of types of recording information increases, and the complexity when a playback is instructed increases further. Therefore, by performing a playback. with identification information being given for each type of the recording information, the ease of operation can be improved further.

Preferably, the identification information is provided so as to correspond to each of the pieces of recording information for which the playback method is different. As a result, even when a plurality of types of information for which the playback method is different, for example, data for CD-DA and a MP3 file, are recorded in a mixed manner on one disk-shaped recording medium, by specifying each piece of identification information, the recording information of each playback method can be specified. Thus, it becomes possible to specify each recording information with a lesser amount of operation, and a playback operation can be performed with efficiency.

The disk playback apparatus may further include: an operation section for specifying a type of the recording information; and an identification information extraction section for extracting, from the disk-shaped recording medium, the identification information corresponding to the recording information of the type specified using the operation section. Preferably, the playback section performs a playback operation on the basis of the identification information extracted by the identification information extraction section. As a result, since the playback of the recording information can be performed by the user himself/herself by specifying the type, only the recording information of the specified type can be played back.

Preferably, the recording information is classified, in accordance with a playback operation, into first recording information in which a display signal is contained and second recording information in which a display signal is not contained. An identification information extraction section for extracting the identification information corresponding to the second recording information from the disk-shaped recording medium when the second display section for performing a display based on the display signal is being used in applications other than this display operation may further be provided. Preferably, the playback section performs a playback operation on the basis of the identification information extracted by the identification information extraction section. As a result, when the display section is being used in another application, for example, a map display for a navigation apparatus, recording information, such as a music source, that does not involve a display can be made a target to be played back in such a manner as to be narrowed in advance. Thus, the ease of operation when the playback operation is instructed can be improved.

Preferably, the operation section is used to select one of the plurality of pieces of identification information extracted by the identification information extraction section, and the playback section performs a playback operation on the basis of one of the pieces of the identification information, which is selected by an operation using the operation section. As a result, it is possible for the user to narrow the recording information by specifying the type, and thereafter to select one piece of recording information that is desired to be played back from among the recording information. Therefore, the ease of operation when one piece of recording information is selectively played back can be improved even more.

Preferably, the playback section sequentially plays back the recording information that is randomly selected on the basis of the identification information extracted by the identification information extraction section. As a result, it is possible to perform a random playback without specifying the recording information of the same type as a target to be played back each time.

### BRIEF DESCRIPTION OF THE DRAWINGS

FIG. 1 shows the overall configuration of a disk playback apparatus according to an embodiment of the present invention;

FIG. 2 shows an operation procedure for identifying the medium type of a disk and the recorded content thereof;

FIG. 3 shows a specific example of the content of a disk loaded into each slot of a disk changer;

FIG. 4 shows a specific example of management information;

FIG. 5 is a flowchart showing an operation procedure for analyzing the content of a disk as a CD medium;

FIG. 6 is a flowchart showing an operation procedure for analyzing the content of a disk as a DVD medium;

FIG. 7 is a flowchart showing an operation procedure when a source is switched for each playback method;

FIG. 8 is a flowchart showing a playback operation in a case where the usage of a display device is taken into consideration; and

FIG. 9 is a flowchart showing an operation procedure for specifying a source and for randomly playing back the recorded content of one or more pseudo-slots corresponding to the specified source.

### DESCRIPTION OF THE PREFERRED EMBODIMENTS

A disk playback apparatus of an embodiment of the present invention will now be described below in detail with reference to the drawings.

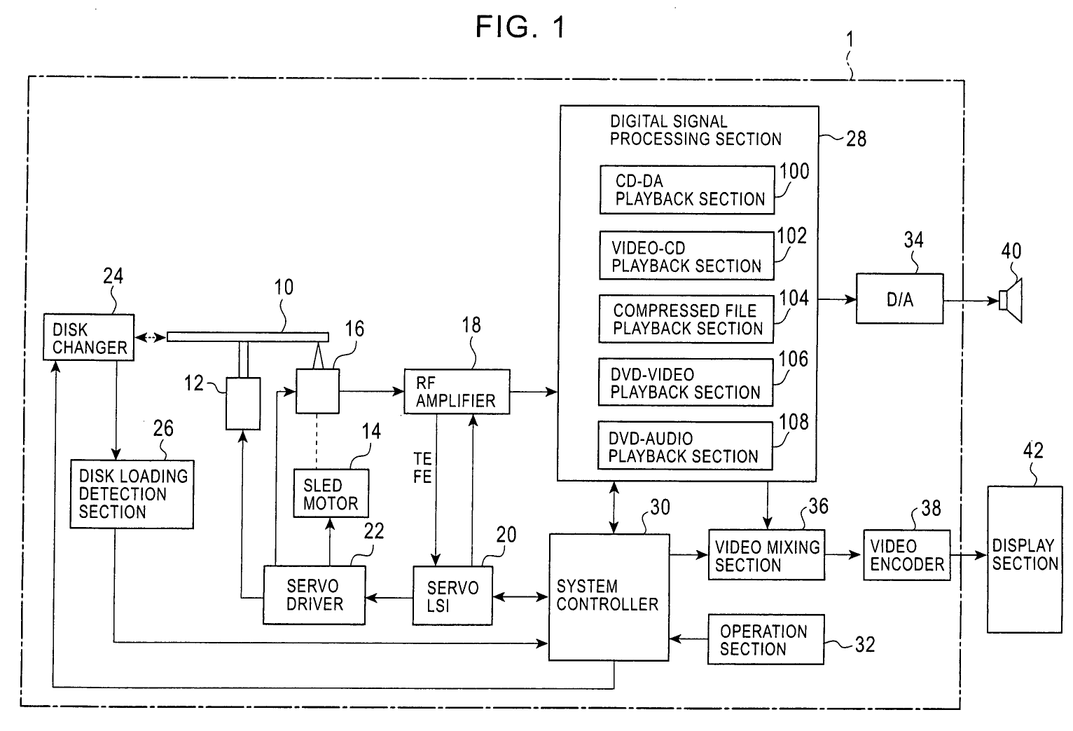

FIG. 1 shows the overall configuration of a disk playback apparatus according to the embodiment of the present invention. A disk playback apparatus 1 of this embodiment shown in FIG. 1 plays back recording information in accordance with a signal read from a disk 10. The disk playback apparatus 1 includes a spindle motor 12, a sled motor 14, an optical pickup 16, an RF amplifier 18, a servo LSI 20, a servo driver 22, a disk changer 24, a disk loading detection section 26,-a digital signal processing section 28, a system controller 30, an operation section 32, a digital-to-analog converter (D/A) 34, a video mixing section 36, and a video encoder 38.

The spindle motor 12 rotates a disk 10 set at a predetermined position at a predetermined speed. The sled motor 14 causes the optical pickup 16 to move in the radial direction of the disk 10. The optical pickup 16 reads a signal recorded on the disk, and includes a semiconductor laser, a photodiode, and a focus lens. The optical pickup 16 includes a focus actuator for causing the focus lens to move nearly at a vertical direction with respect to the recording surface of the disk 10, and a tracking actuator for causing the focus lens to move in the radial direction of the disk 10.

The RF amplifier 18 generates an RF signal by amplifying a signal sent from the optical pickup 16 and by performing an equalizer process thereon, and sends the RF signal to the digital signal processing section 28. Furthermore, the RF amplifier 18 generates a focus error (FE) signal required for focus servo and a tracking error (TE) signal required for tracking servo, and sends the signals to the servo LSI 20.

The servo LSI 20 performs various servo control. More specifically, the servo LSI 20 performs phase compensation and amplification on the focus error signal sent from the RF amplifier 18, and generates a focus actuator control signal required to control the driving state of the focus actuator within the optical pickup 16. Furthermore, based on the control signal sent from the RF amplifier 18, the servo LSI 20 generates a spindle motor control signal required to control the driving state of the spindle motor 12. These signals generated by the servo LSI 20 are sent to the servo driver 22.

Based on the focus actuator control signal sent from the servo LSI 20, the servo driver 22 generates a driving voltage for the tracking actuator of the optical pickup 16. The servo driver 22 generates a driving voltage for the sled motor 14 on the basis of the sled motor control signal sent from the servo LSI 20. Furthermore, the servo driver 22 generates a driving voltage for the spindle motor 12 on the basis of the spindle motor control signal sent from the servo LSI 20.

The disk changer 24 has a plurality of slots (for example, six slots) to which a plurality of disks 10 of CD media or DVD media can be loaded. The disk changer 24 performs an operation for moving the disk 10 loaded into one of the slots and setting it at a predetermined position at which a recording signal can be read, and for moving the disk 10 set at the predetermined position and housing it in the slot again. The disk loading detection section 26 detects the presence or absence of the disk 10 loaded into each slot of the disk changer 24.

The digital signal processing section 28 performs synchronization detection and demodulation processes on the RF signal sent from the RF amplifier 18. Thereafter, the digital signal processing section 28 performs a predetermined decoding process in accordance with the content recorded on the disk 10, and plays back and reproduces the recorded audio or video data. In this embodiment, it is assumed that, as the disk 10, a CD medium or a DVD medium is used, and as the recorded content (the recording information), one of (1) data for CD-DA, (2) data for video-CD, (3) data for DVD-audio, (4) data for DVD-video, (5) an MP3 file, and (6) a WMA file is recorded. Furthermore, there are cases in which a plurality of pieces of content (for example, data for CD-DA and an MP3 file) are recorded in a mixed manner on one disk 10.

In order to perform a decoding process corresponding to these various pieces of recorded content, the digital signal processing section 28 includes a CD-DA playback section 100, a video-CD playback section 102, a compressed file playback section 104, a DVD-video playback section 106, and a DVD-audio playback section 108. When the content recorded on the disk 10 is identified as data for CD-DA, the CD-DA playback section 100 plays back this content and reproduces audio data. When the content recorded on the disk 10 is identified as data for video-CD, the video-CD playback section 102 plays back this content and reproduces audio data and video data. When the content recorded on the disk 10 is identified as an MP3 file or a WMA file, the compressed file playback section 104 plays back this content and reproduces audio data. When the content recorded on the disk 10 is identified as data for DVD-video, the DVD-video playback section 106 plays back this content and reproduces audio data and video data. When the content recorded on the disk 10 is identified as data for DVD-audio, the DVD-audio playback section 108 plays back this content and reproduces audio data.

The system controller 30 controls the playback operation of the disk playback apparatus 1 by sending various servo instructions to the servo LSI 20 and by instructing the disk changer 24 to move the disk 10 loaded into each slot and house it. Furthermore, the system controller 30 identifies the medium type and the recorded content of the disk 10 loaded into each slot of the disk changer 24, and instructs the digital signal processing section 28 to perform a playback operation in accordance with this identified result.

The operation section 32 is used for a user to perform various operations. The operation section 32 includes a cursor key and a determination key required to instruct, for example, a playback operation and a random playback operation in which a medium type or a pseudo-slot (to be described later) are specified.

The digital-to-analog converter 34 converts audio data sent from the digital signal processing section 28 into an analog audio signal of a predetermined channel (for example, a 5.1 channel). This analog audio signal for each channel is amplified by an amplifier (not shown), and thereafter, the analog audio signal is reproduced from a speaker 40.

The video mixing section 36 mixes video data of an operation screen, etc., and text data of movie subtitles, etc., which are sent from the system controller 30, to the video data sent from the digital signal processing section 28. The video encoder 38 converts video data sent from the video mixing section 36 into a video signal in a predetermined format (for example, an NTSC format). This video signal is sent to the display section 42, whereby a video image is displayed on the screen thereof.

The above-described system controller 30 corresponds to the recording information analysis section, the management information creation section, and the identification information extraction section. The digital signal processing section 28 and the system controller 30 correspond to the playback section. The video encoder 38 and the display section 42 correspond to the first and second display sections. The disk changer 24 corresponds to the disk housing section. The operation section 32 corresponds to the operation section.

The disk playback apparatus 1 of this embodiment has such a configuration. Next, a description will be given below of an operation for identifying the medium type and the recorded content of each disk 10 loaded into the disk changer 24 and a playback operation performed on the basis of this identified result.

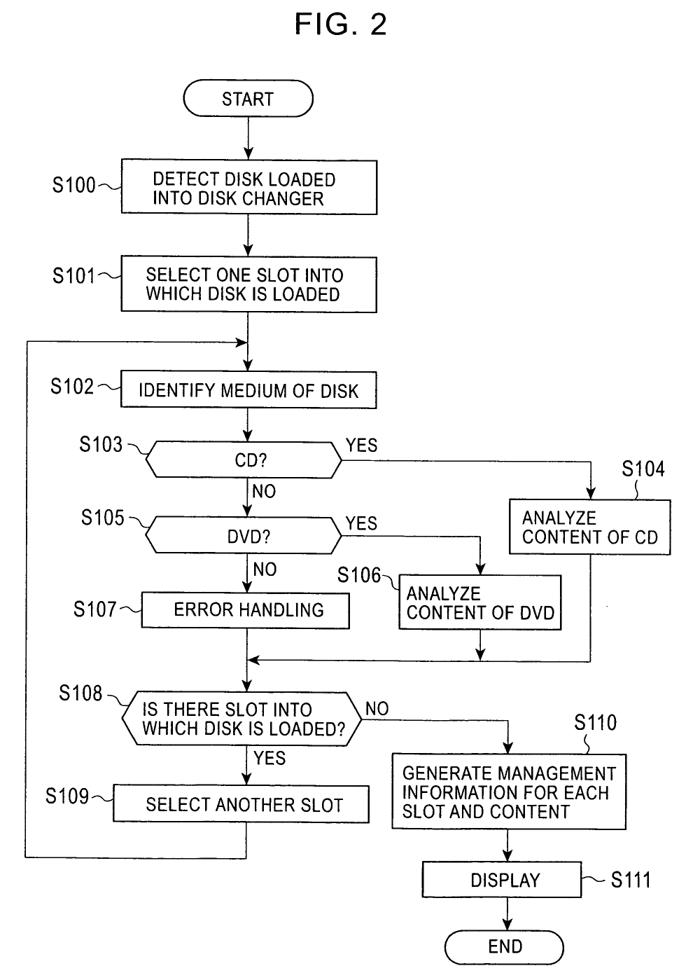

FIG. 2 shows the operation procedure for identifying the medium type and the recorded content of the disk 10. When the power is switched on or the disk changer 24 is set to a predetermined value, the system controller 30 detects the disk 10 loaded into each slot of the disk changer 24 on the basis of the detection result by the disk loading detection section 26 (step S100).

Next, the system controller 30 selects one slot to which the disk 10 is loaded (step S101), and identifies the medium type of the disk 10 loaded into this slot (step S102). This identification is performed in a state in which the disk 10 is actually taken out from the slot and is set at the position where playback is possible. For a method of identifying which one of a CD medium or a DVD medium the disk 10 is, various methods have previously been used. For example, a focus error signal which is detected when the optical pickup 16 is moved perpendicularly to the recording surface of the disk 10 can be observed to identify as to which one of a CD medium or a DVD medium the disk 10 is on the basis of the number of S-shaped curves which appear and the signal level.

Next, the system controller 30 determines whether or not the disk 10 of interest, which is loaded into one slot, is a CD medium, on the basis of the identification result of the disk medium (step S103). In the case of a CD medium, an affirmative determination is made. Next, the system controller 30 analyzes the recorded content of this disk 10 (step S104). As described above, when the disk 10 is a CD medium, the recorded content is basically one of data for CD-DA, data for video-CD, an MP3 file, and a WMA file, or a combination thereof, and an analysis as to which one of them the recorded content corresponds to is performed.

When the disk 10 is not a CD medium, a negative determination is made in the determination of step S103. Next, the system controller 30 determines whether or not the disk 10 is a DVD medium (step S105). When the disk 10 is a DVD medium, an affirmative determination is made. Next, the system controller 30 analyzes the recorded content of this disk 10 (step S106). As described above, when the disk 10 is a DVD medium, the recorded content is basically one of data for DVD-audio, data for DVD-video, an MP3 file, and a WMA file, or a combination thereof, and an analysis as to which one of them the recorded content corresponds to is performed.

When the disk 10 is not a DVD medium, a negative determination is made in the determination of step S105. This is a case in which the disk 10 is neither a CD medium nor a DVD medium, and the system controller 30 performs predetermined error handling (step S107).

After the error handling (step S107) or after the analysis of the content of the disk 10 in steps S104 and S106, the system controller 30 determines whether or not there is another slot into which the disk 10 for which analysis is not completed is loaded (step S108). When there is such a slot, an affirmative determination is made. Next, the system controller 30 selects another slot into which the disk 10 for which analysis is not completed is loaded (step S109). The process thereafter returns to step S102 above, and the operation for identifying the medium type of the disk 10 loaded into this slot and subsequent steps are performed again.

When there are no other slots into which the disk 10 for which analysis is not yet completed is loaded, a negative determination is made in step S108. Next, the system controller 30 creates management information for each slot of the disk changer 24 and for each of the pieces of recorded content of the disk 10 loaded into each slot (step S110), and thereafter, displays the content on the display section 42 via the video mixing section 36 and the video encoder 38 (step S111).

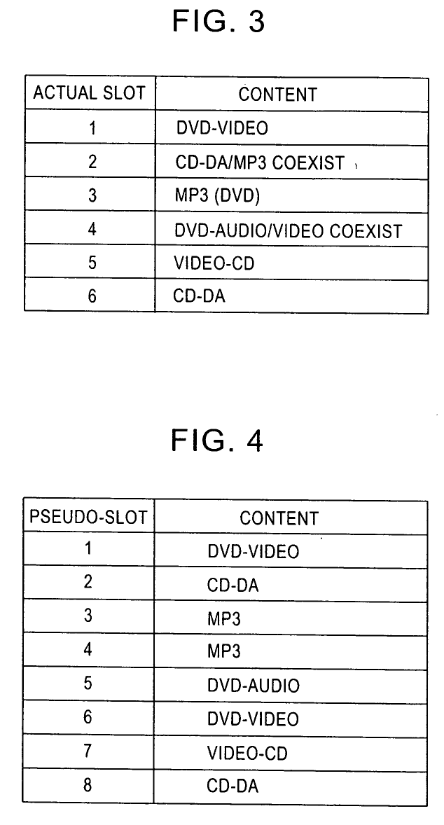

FIG. 3 shows a specific example of the content of the disk 10 loaded into each slot of the disk changer 24. As shown in FIG. 3, the medium type and the recorded content of the disk 10 loaded into each slot are as follows. The actual slots provided in the disk changer 24 are hereinafter referred to as “actual slots”, and virtual slots (to be described later) introduced in this embodiment are hereinafter referred to as “pseudo-slots” so that the slots are distinguished. The number of each pseudo-slot corresponds to the identification information set for each type of the recorded content.
Actual slot 1: the disk 10 of a DVD medium is loaded, and the recorded content is data for DVD-video.
Actual slot 2: the disk 10 of a CD medium is loaded, and the recorded content is provided in such a manner that data for CD-DA and an MP3 file coexist.
Actual slot 3: the disk 10 of a DVD medium is loaded, and the recorded content is an MP3 file.
Actual slot 4: the disk 10 of a CD medium is loaded, and the recorded content is provided in such a manner that data for DVD-audio and data for DVD-video coexist.
Actual slot 5: the disk 10 of a CD medium is loaded, and the recorded content is video-CD.
Actual slot 6: the disk 10 of a CD medium is loaded, and the recorded content is CD-DA.

In the six actual slots of the disk changer 24, six disks 10 of such medium type and recorded content are loaded. In the management information created in step S110 of FIG. 2, pseudo-slots which are set in accordance with the following rules are assumed as units.
(Rule 1) A different pseudo-slot is assigned to a different actual slot.
(Rule 2) A pseudo-slot is assigned to only the actual slot to which the disk 10 is actually loaded.
(Rule 3) When a plurality of pieces of data for which the playback method is different are recorded on the same actual slot, different pseudo-slots are assigned so as to correspond to the respective pieces of data.

FIG. 4 shows a specific example of management information created in accordance with the above rules. As shown in FIG. 4, the content of each pseudo-slot is as follows.
Virtual slot 1: since only one type of data (data for DVD-video) is recorded on the disk 10 loaded into the actual slot 1, the content of the actual slot 1 is assigned to the pseudo-slot 1.
Virtual slot 2: since two types of data (data for CD-DA and an MP3 file) are recorded on the disk 10 loaded into the next actual slot, one of them (data for CD-DA) is assigned to the pseudo-slot 2.
Virtual slot 3: in the pseudo-slot 3, the other data (the MP3 file) recorded on the disk 10 loaded into the actual slot 2 is assigned.
Virtual slot 4: since only one type of data (the MP3 file) is recorded on the disk 10 loaded into the next actual slot 3, the content of the actual slot 3 is assigned to the pseudo-slot 4.
Virtual slot 5: since two types of data (data for DVD-audio and data for DVD-video) are recorded on the disk 10 loaded into the next actual slot 4, one of them (data for DVD-audio) is assigned to the pseudo-slot 5.
Virtual slot 6: in the pseudo-slot 6, the other data (the data for DVD-video) recorded on the disk 10 loaded into the actual slot 4 is assigned.
Virtual slot 7: since only one type of data (the data for video-CD) is recorded on the disk 10 loaded into the next actual slot 5, the content of the actual slot 5 is assigned to the pseudo-slot 7.
Virtual slot 8: since only one type of data (the data for CD-DA) is recorded on the disk 10 loaded into the next actual slot 6, the content of the actual slot 6 is assigned to the pseudo-slot 8.

As described above, in the example shown in FIG. 3, since six disks 10 are loaded into six actual slots of the disk changer 24, and two types of data are recorded on the disks 10 loaded into the actual slots 2 and 4, a total of eight pseudo-slots are set.

In step S111 of FIG. 2, a display operation is performed in such a manner that the number of pseudo-slots and the content of each pseudo-slot are known. For example, the content shown in FIG. 4 may be displayed in a display mode as is, or a display may be made by changing only the display mode while maintaining substantially the same content.

Next, a description will be given below of a specific technique for analyzing the content in each of the cases where the disk 10 is a CD medium and a DVD medium.

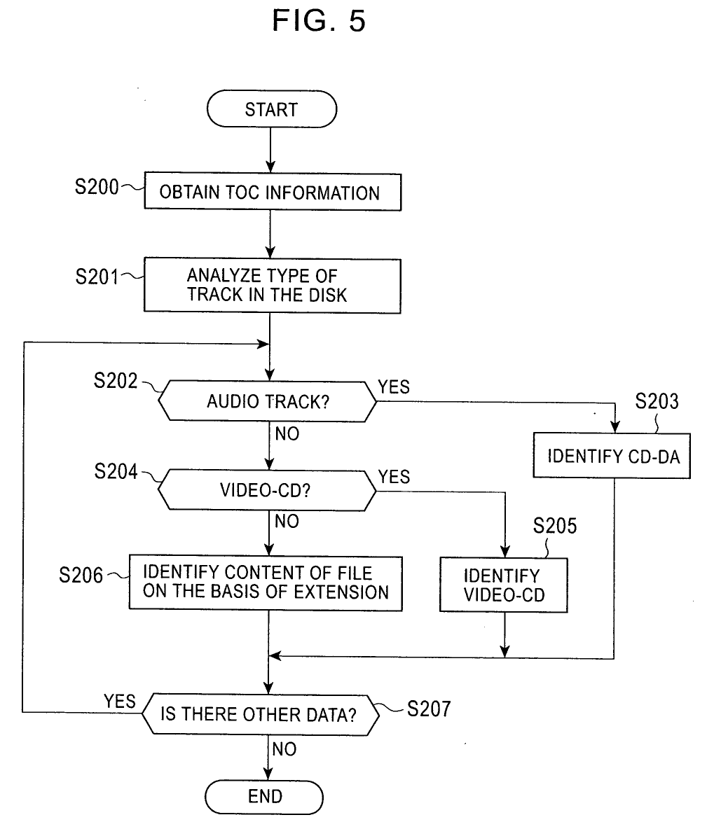

FIG. 5 is a flowchart showing the operation procedure for analyzing the content of the disk 10 as a CD medium, in which the details of the operation of step S104 of FIG. 2 are shown. When it is determined that the disk 10 is a CD medium, first, the system controller 30 obtains the TOC (Table of Contents) information recorded in the lead-in area of the disk 10 (step S200), and analyzes the track type in the disk (step S201).

Next, the system controller 30 determines whether or not the track in the disk is an audio track on the basis of the analysis result (step S202). In the case of an audio track, an affirmative determination is made, and the area corresponding to this track is identified as data for CD-DA (step S203).

When the track in the disk is not an audio track, a negative determination is made in the determination of step S202. In this case, since the track in the disk is a data track, next, the system controller 30 determines whether or not the area is data for video-CD (step S204). This determination is performed by reading INFO.VCD (MSF=00:04:00 fixed) and by checking whether the identifier is “video-CD”. When the identifier is video-CD, an affirmative determination is made in the determination of step S204, and the area corresponding to this track is identified as data for video-CD (step S205).

When the identifier is not video-CD, a negative determination is made in the determination of step S204. Next, the system controller 30 identifies the content of the file on the basis of the extension contained in the file name (step S206). For example, when the extension of the file name is “.MP3”, this file is identified as an MP3 file. When the extension of the file name is “.WMA”, it is determined that this file is a WMA file. Furthermore, when the extension of the file name is “.BIN”, it is determined that this file is a program update file.

In the case of a program update file, since the entire disk 10 is a disk for update data, the disk is not the target for a normal playback operation, and this disk 10 is excluded from the playback target. That is, it is assumed that the disk 10 is loaded into the slot of interest, and the process proceeds to step S108 of FIG. 2, where the determination for the presence or absence of another slot is made.

When the analysis of the content corresponding to the audio track or the data track is completed in this manner, next, the system controller 30 determines whether or not another piece of data exists in the same disk 10 (step S207). In this embodiment, there are cases in which data for which the playback method is different as in the disk 10 loaded into the actual slot 2 is recorded in a mixed manner. In this case, an affirmative determination is made, and the determination operation of step S202 and subsequent steps are performed again on the other data. When another piece of data does not exist, a negative determination is made in step S207, and the series of content analysis operations for one disk 10 loaded into the actual slot of interest is completed.

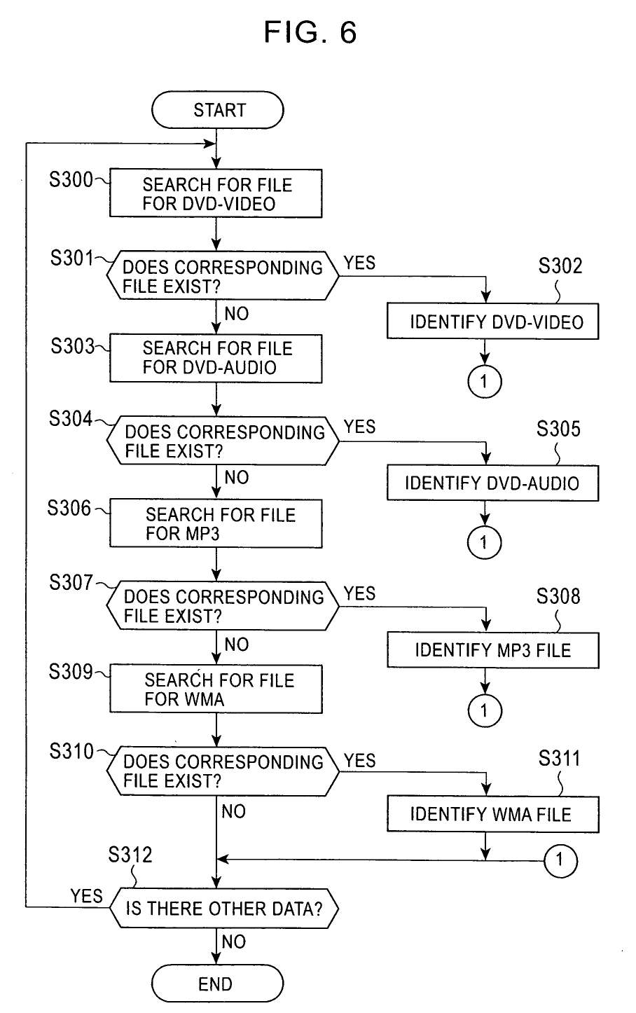

FIG. 6 is a flowchart showing the operation procedure for analyzing the content of the disk 10 as a DVD medium, in which the details of the operation of step S106 of FIG. 2 are shown. When it is determined that the disk 10 is a DVD medium, first, the system controller 30 searches, for example, folders and files at the root of a UDF (Universal Disk Format) file system and lower folders and files (step S300) for “VIDEO_TS¥VIDEO_TS.IFO”, which is a file for DVD-video, in order to determine whether or not this file exists (step S301). When this file exists, an affirmative determination is made, and the area corresponding to this file is identified as data for DVD-video (step S302).

When “VIDEO_TS¥VIDEO_TS.IFO” does not exist, a negative determination is made in step S301. Next, the system controller 30 searches for “AUDIO_TS¥AUDIO_TS.IFO”, which is a file for DVD-audio (step S303) in order to determine whether or not this file exists (step S304). When this file exists, an affirmative determination is made, and the area corresponding to this file is identified as data for DVD-audio (step S305).

When “AUDIO_TS¥AUDIO_TS.IFO” does not exist, a negative determination is made in step S304. Next, the system controller 30 searches for an MP3 file whose extension is “.MP3” (step S306) in order to determine whether or not this file exists (step S307). When this file exists, an affirmative determination is made, and this file is identified as an MP3 file (step S308).

When the MP3 file does not exist, a negative determination is made in step S307. Next, the system controller 30 searches for a WMA file whose extension is “.WMA” (step S309) in order to determine whether or not this file exists (step S310). When this file exists, an affirmative determination is made, and this file is identified as a WMA file (step S311).

In this manner, when the identification of various files is completed (steps S302, S305, S308, and S311), or when the WMA file does not exist and a negative determination is made in the determination of step S310, next, the system controller 30 determines whether or not another piece of data (file) exists in the same disk 10 (step S312). In this embodiment, there are cases in which data for which the playback method is different is recorded in a mixed manner as in the disk 10 loaded into the actual slot 4. In this case, an affirmative determination is made, and the processing of file searching in step S300 and subsequent steps is performed on the other data again. When no other data exists, a negative determination is made in step S312, and the series of content analysis operations for one disk 10 loaded into the actual slot of interest is completed.

In this manner, in the disk playback apparatus 1 of this embodiment, the concept of pseudo-slots is introduced in addition to the actual slots. In this pseudo-slot, if the disk 10 differs or the playback method differs even in the same disk 10, a different slot number is given. Therefore, even when data for which the playback method is different as in a CD-R or a DVD-R and data for which the playback method is different are actually recorded in a mixed manner, it is possible for the user to handle each piece of data within the same disk in a manner similar to individual disks 10 loaded into individual pseudo-slots. Thus, the ease of operation when a playback instruction is given by targeting each piece of data can be improved. Furthermore, since the user can specify each pseudo-slot without being conscious about whether each disk 10 loaded into the disk changer 24 is a CD medium or a DVD medium, the operation can be simplified, and the ease of operation can be improved even more.

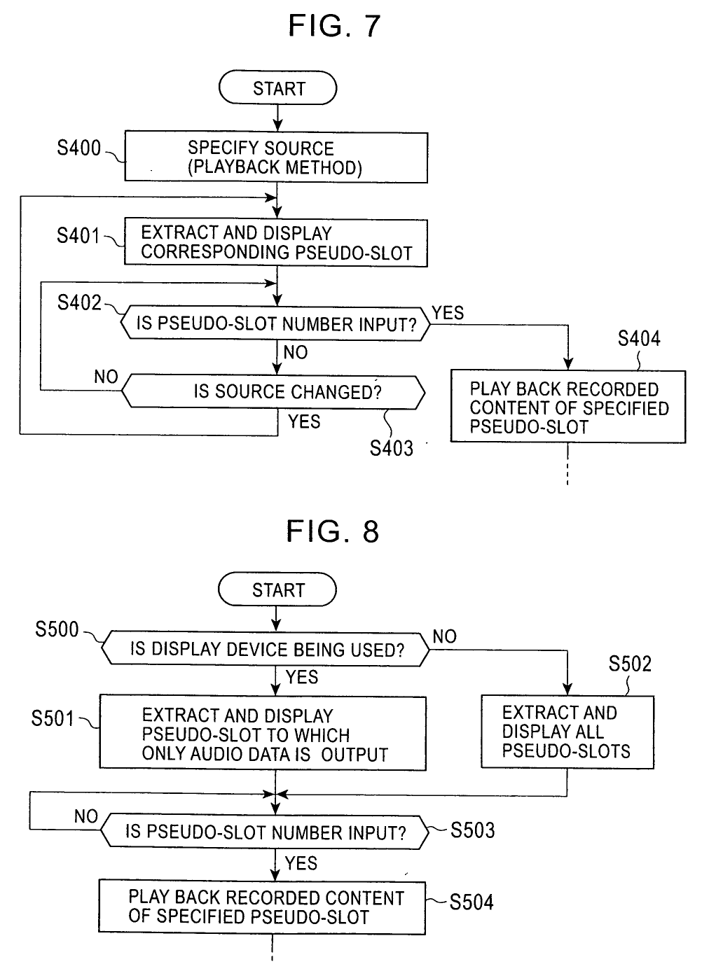

Next, a description will be given below of a specific example of a playback operation using the above-described pseudo-slots. FIG. 7 is a flowchart showing the operation procedure when a source is switched for each playback method.

When the user specifies the source by operating the operation section 32 (step S400), the system controller 30 extracts and displays the pseudo-slot corresponding to the specified source (step S401). The “source” in this embodiment refers to each piece of the recording content for which the playback method is common, and is not related to the difference in the medium type and the difference in the pseudo-slot number. For example, in step S400, when “MP3” is specified as the source, the system controller 30 extracts and displays the pseudo-slots 3 and 4 in which this MP3 is recording content on the basis of the management information shown in FIG. 4 (step S401).

Next, the system controller 30 determines whether or not one of the numbers of the displayed pseudo-slots 3 and 4 is entered by the user (step S402). When no number is entered, a negative determination is made, and thereafter, the system controller 30 determines whether or not the change of the source is instructed by the user (step S403). When the change of the source is not instructed, a negative determination is made, and the determination operation of step S402 is repeated. When the change of the source is instructed, an affirmative determination is made in the determination of step S403, and the process returns to step S401, where the processing of the operation for extracting the corresponding pseudo-slot and subsequent steps are performed again.

When the pseudo-slot number is entered and an affirmative determination is made in the determination of step S402, the system controller 30 performs control for playing back the recorded content corresponding to the specified pseudo-slot (step S404). More specifically, an instruction for taking out the disk 10 from the actual slot corresponding to this pseudo-slot is sent to the disk changer 24, and instructions for reading and playing back the recorded content from the disk 10 set at a predetermined position are sent to the servo LSI 20 and the digital signal processing section 28. As a result, in the corresponding playback section within the digital signal processing section 28, a playback operation for the recorded content that is read is performed, and only the audio data or both the audio data and the video data are reproduced. Then, audio sound corresponding to the audio data is sent from the speaker 40, and a video signal corresponding to the video data is sent to the display section 42, whereby a video display is generated.

FIG. 8 is a flowchart showing a playback operation in which the usage of the display device 42 is taken into consideration. The system controller 30 determines whether or not the display section 42 is being used in another application (step S500). For example, it is assumed that the disk playback apparatus 1 is incorporated in a vehicle, and when a navigation apparatus (not shown) is operating, the display section 42 is used for a map display. In such a case, an affirmative determination is made in the determination of step S500, and the system controller 30 extracts and displays the pseudo-slot corresponding to the source from which only the audio data is reproduced and video data is not reproduced during playback (step S501). In the example shown in FIG. 4, the pseudo-slots 2 to 5, and 8 are extracted. When the display section 42 is not being used in another application, a negative determination is made in the determination of step S500, and all the pseudo-slots are extracted and displayed (step S502).

Next, the system controller 30 determines whether or not any one of the numbers of the displayed pseudo-slots is entered by the user (step S503). When no number is entered, a negative determination is made, and this determination is repeated. When one of the numbers within the displayed pseudo-slots is entered, an affirmative determination is made in the determination of step S503, and the system controller 30 performs control so that the recorded content corresponding to the specified pseudo-slot is played back (step S504).

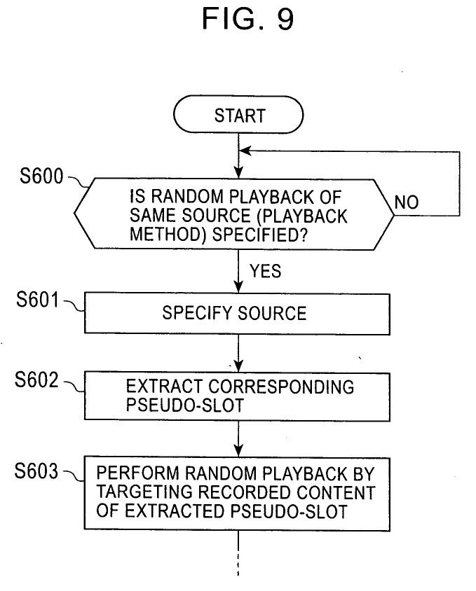

FIG. 9 is a flowchart showing the operation procedure for specifying a source and for randomly playing back the recorded content of one or more pseudo-slots corresponding to the specified source.

The system controller 30 determines whether or not the operation section 32 is operated by the user and a random playback of the same source is instructed (step S600). When this instruction is not entered, a negative determination is made, and this determination is repeated. Furthermore, after this instruction is entered and an affirmative determination is made in the determination of step S600, when the source is specified by the user (step S601), the system controller 30 extracts the pseudo-slot corresponding to the specified source (step S602). Next, the system controller 30 starts control for performing a random playback by targeting the recorded content of the extracted pseudo-slot (step S603). For example, when “MP3” is specified as the source, the pseudo-slots 3 and 4 are extracted, and a random playback operation is started. In this random playback operation, playback music is randomly selected by targeting all the MP3 files without discriminating the pseudo-slots 3 and 4, and the playback music is played back in the selected order.

As described above, even when a plurality of types of recorded content are recorded on the disk 10, the playback of each recorded content can be performed by specifying the pseudo-slot number as the identification information corresponding to each recorded content. Thus, the ease of operation when the recorded content is played back using the disk 10 in which a plurality of types of recorded content are recorded in a mixed manner can be improved. Furthermore, by displaying the content of the management information containing the pseudo-slot number corresponding to each recorded content, it becomes possible for the user to confirm the pseudo-slot number corresponding to the recorded content of each disk 10, and thus, the ease of operation when the pseudo-slot is specified can be improved. Moreover, in this management information, information for specifying the pseudo-slot number and the type of recorded content corresponding to this pseudo-slot number (for example, the name indicating the type of data, such as CD-DA and MP3) is contained. Therefore, it becomes easy for the user to specify the pseudo-slot number and the type of the recorded content corresponding to each pseudo-slot number.

As a result of providing the disk changer 24, it is possible to perform a playback with the pseudo-slot number being specified with respect to one or more pieces of content recorded on each of a plurality of disks 10. As a result, the ease of operation when the recorded content is played back using one or more disks 10 in which a plurality of types of recorded content are recorded in a mixed manner can be improved.

The present invention is not limited to the above-described embodiments, and various modifications are possible within the spirit and scope of the present invention. In the above-described embodiments, a description is given by using as an example a case in which the disk changer 24 is provided with a plurality of actual slots and the disks 10 are loaded into all the actual slots. However, a vacant actual slot to which the disk 10 is not loaded may exist. Furthermore, the present invention can also be applied to a case in which the disk changer 24 is not used and one disk 10 is used. In this case, when various types of data corresponding to a plurality of sources are recorded on one disk 10, pseudo-slots corresponding to the number of sources are provided.

In the above-described embodiments, a description is given of a case in which data corresponding to each source is recorded on the disk 10. Alternatively, another recording medium may be used. For example, the present invention can also be applied to a case in which data for CD-DA and an MP3 file are stored in advance in a semiconductor memory and a hard disk unit, and these are read therefrom.

As examples of a compressed file, an MP3 file and a WMA file are considered. Alternatively, various files compressed using another compression method may be included.

1. A disk playback apparatus comprising:
an analysis section for analyzing the type of recording information recorded on a disk-shaped recording medium to be played back;
a management information creation section for creating management information such that each of a plurality of pieces of the recording information corresponds to different identification information on the basis of the analysis performed by the analysis section when a plurality of different types of recording information are recorded on the disk-shaped recording medium; and
a playback section for performing a playback operation on the basis of the recording information corresponding to the identification information.

2. The disk playback apparatus according to claim 1, further comprising a first display section for displaying the content of the management information created by the management information creation section.

3. The disk playback apparatus according to claim 1, wherein the management information comprises the identification information and information regarding the type of the recording information corresponding to the identification information.

4. The disk playback apparatus according to claim 2, further comprising a disk housing section in which a plurality of the disk-shaped recording media can be housed and from which one of the disk-shaped recording media, which is to be played back by the playback section, is selectively taken out of the disk housing section,
wherein the management information creation section creates the management information corresponding to a plurality of the disk-shaped recording media that are actually housed in the disk housing section.

5. The disk playback apparatus according to claim 4, wherein different identification information is used with respect to the combination of the housing position of the disk housing section and one or a plurality of types of the pieces of the recording information of the disk-shaped recording medium housed at each housing position.

6. The disk playback apparatus according to claim 5, wherein the identification information is a virtual slot number having a serial number.

7. The disk playback apparatus according to claim 2, wherein the disk-shaped recording medium include at least a CD and a DVD, and the playback section performs a playback operation on both the CD and the DVD.

8. The disk playback apparatus according to claim 2, wherein the identification information is provided so as to correspond to each of the pieces of recording information for which the playback method is different.

9. The disk playback apparatus according to claim 2, further comprising:
an operation section for specifying a type of the recording information; and
an extraction section for extracting, from the disk-shaped recording medium, the identification information corresponding to the recording information of the type specified using the operation section,
wherein the playback section performs a playback operation on the basis of the identification information extracted by the extraction section.

10. The disk playback apparatus according to claim 2, wherein the recording information is classified, in accordance with a playback operation, into a first section in which a display signal is contained and a second section in which a display signal is not contained,
an extraction section for extracting the identification information corresponding to the second section from the disk-shaped recording medium when a second display section for performing a display based on the display signal is being used in applications other than this display operation, and
the playback section performs a playback operation on the basis of the identification information extracted by the extraction section.

11. The disk playback apparatus according to claim 10, wherein the operation section is used to select one of the plurality of pieces of identification information extracted by the extraction section, and the playback section performs a playback operation on the basis of the identification information.

12. The disk playback apparatus according to claim 10, wherein the playback section sequentially plays back the recording information that is randomly selected on the basis of the identification information extracted by the extraction section.

13. A disk playback method comprising:
analyzing a type of recording information recorded on a disk-shaped recording medium to be played back;
creating management information such that each of a plurality of the pieces of the recording information corresponds to different identification information on the basis of the analysis result when a plurality of different types of the recording information are recorded on the disk-shaped recording medium; and
performing a playback operation on the basis of the recording information corresponding to the identification information.

14. The disk playback method according to claim 13, further comprising displaying the content of the management information created.

15. The disk playback method according to claim 13, wherein the management information comprises the identification information and information regarding the type of the recording information corresponding to the identification information.

16. The disk playback method according to claim 13, further comprising providing a disk housing section in which a plurality of the disk-shaped recording medium can be housed and from which one of the disk-shaped recording medium to be played back is selectively taken out of the disk housing section, and
the management information corresponding to a plurality of the disk-shaped recording media that are actually housed in the disk housing section is created.

17. The disk playback method according to claim 13, wherein the identification information is provided so as to correspond to each of the pieces of the recording information for which the playback method is different.

18. The disk playback method according to claim 13, further comprising displaying the content of the management information created, and
the management information comprises the identification information and information regarding the type of the recording information corresponding to the identification information.

19. The disk playback method according to claim 13, further comprising displaying the content of the management information created, and
the management information is provided so as to correspond to each of the pieces of the recording information for which the playback method is different.

20. The disk playback method according to claim 13, wherein the management information comprises the identification information and information regarding the type of the recording information corresponding to the identification information, and the management information is provided so as to correspond to each of the pieces of the recording information for which the playback method is different.

21. A playback method comprising:
determining each type of recording information recorded on each recording medium located in the physical slots of a playback apparatus;
producing classification data classifying each type of recording information determined to be recorded on each recording medium;
generating a virtual slot for each type of recording information on each recording medium;
associating each virtual slot with the corresponding classification data for each type of recording information; and
illustrating the contents of each virtual slot on a display by using the classification data, wherein at least two virtual slots displayed correspond to a recording medium in one physical slot in the playback apparatus.
